(19) United States
(12) Patent Application Publication
(10) Pub. No.: US 2024/0418595 A1
(43) Pub. Date: Dec. 19, 2024

(54) FLUID METER DETECTING AND DISTINGUISHING A LEAK AND AN OFFSET PROBLEM

(71) Applicant: SAGEMCOM ENERGY & TELECOM SAS, BOIS-COLOMBES (FR)

(72) Inventors: Abbas SABRAOUI, BOIS-COLOMBES (FR); Oussama ABID, BOIS-COLOMBES (FR); Ahmet Samed BASTURK, BOIS-COLOMBES (FR)

(21) Appl. No.: 18/735,531

(22) Filed: Jun. 6, 2024

(30) Foreign Application Priority Data
Jun. 14, 2023 (FR) FR2306077

(51) Int. Cl. G01M 3/26; F16K 37/00; G01F 1/66; G01F 25/10

(52) U.S. Cl. CPC G01M 3/26; F16K 37/0041; G01F 1/66; G01F 25/10

(57) ABSTRACT

A monitoring method is implemented in a fluid meter (1) which includes a measuring device (6) arranged to measure a flow rate of the fluid and a valve (12). The monitoring method includes a preliminary phase including the step of acquiring first flow rate measurements, and a detection phase, carried out when the flow rate remains non-zero and less than a predetermined first threshold for at least one predetermined duration, and including the steps of verifying that the valve is open and, if this is the case, closing the valve, acquiring at least one second flow rate measurement, and detecting a fluid leak if the flow rate is zero.

The invention relates to the field of fluid meters, and in particular, ultrasonic fluid meters.

### BACKGROUND OF THE INVENTION

An ultrasonic fluid meter very conventionally comprises a conduit, wherein the fluid circulates, and an ultrasonic measuring device comprising an upstream transducer (network side) and a downstream transducer (installation side of the subscriber). Each transducer successively plays the role of an ultrasonic signal emitter and receiver. The upstream transducer thus emits an ultrasonic signal in the conduit, which is received by the downstream transducer after having travelled a predefined path in the fluid (of fully controlled length). Then, the downstream transducer itself emits an ultrasonic signal, which is received by the upstream transducer after having travelled the predefined path in the fluid (in the other direction). The ultrasonic measuring device thus evaluates the speed of the fluid from the transit times of the ultrasonic signals, then the flow rate of the fluid from the speed of the fluid. Estimating the flow rate of the fluid makes it possible to evaluate and to bill the quantity of fluid consumed.

The operating principle of the ultrasonic measuring device is therefore based on measuring the transit time of the ultrasonic signals between the two transducers. The basic equations are as follows:

$$v = L / ( t\_AB - t\_BA ) , \qquad ( equation 1 )$$

where v is the speed of the fluid, L is the distance between the transducers, t_AB is the transit time between the upstream transducer and the downstream transducer, and t_BA is the transit time between the downstream transducer and the upstream transducer.

$$Q = A * v , \qquad ( equation 2 )$$

where Q is the volumetric flow rate and A is the cross-section of the conduit.

However, in practice, it is observed that at zero flow rate, the transit time between the upstream transducer and the downstream transducer (t_AB) is not however equal to the transit time between the downstream transducer and the upstream transducer (t_BA). This phenomenon is due to the mechanical and electronic tolerances of the measuring chain integrated in the ultrasonic measuring device. This zero flow rate transit time difference is called “offset error”, and that will be called “offset” in the rest of this document.

To avoid degrading the precision of the meter, it is therefore necessary to calibrate the meter to zero flow rate in order to consider its offset value.

Thus, the speed is obtained, by using the following equation:

$$V = L / ( t AB - t BA - offset ) . \qquad ( equation 3 )$$

In FIG. 1, an example of measuring the zero flow rate offset of an ultrasonic water meter is seen, before calibration (points P1) and after calibration (points P2). Before calibration, it is observed that the offset is centred around 2 L/h, which resembles a small trickling leak. The calibration of the offset aims to return the curve to zero to avoid any erroneous measurement.

This offset poses a quite particularly problem.

It is naturally very advantageous to be able to detect a fluid leak in the installation downstream of the meter.

A method of the prior art is known, consisting of detecting a leak by searching for the presence of a constant, but non-zero flow rate. However, a deviation of the ultrasonic measuring device, or an incorrectly calibrated electronic offset, can generate an erroneous flow rate which can last indefinitely. The value of this flow rate can vary according to the temperature of the water.

It is therefore very difficult to make the difference between an incorrectly calibrated offset and a real leak and this, never having the certainty that the actual flow rate is actually zero.

### Aim of the Invention

The invention aims, in a fluid meter, to detect an actual leak downstream of the meter or an offset problem, by correctly distinguishing these two events.

### SUMMARY OF THE INVENTION

In view of achieving this aim, a monitoring method is proposed, implemented in a fluid meter, which comprises:
a conduit, wherein a fluid circulates;
a measuring device arranged to measure a flow rate of the fluid;
a valve located upstream of the measuring device;
a processing unit;
   the monitoring method being implemented in the processing unit and comprising a preliminary phase comprising the step of acquiring first flow rate measurements;
the monitoring method further comprising a detection phase, carried out when the flow rate remains non-zero and less than a predetermined first threshold for at least one predetermined duration, and comprising the steps of:
verifying that the valve is open and, if this is the case, closing the valve;
acquiring at least one second flow rate measurement;
detecting a fluid leak if the flow rate is zero.

When the flow rate remains non-zero and low for a relatively long duration, which means that it is possible that a leak is present in the installation downstream of the meter, or although the measuring device has an offset problem. The closing of the valve thus makes it possible to create a zero flow rate (certainly), which makes it possible to detect and to distinguish these two events.

In addition, a monitoring method such as described above is proposed, wherein the detection phase comprises the steps, following the acquisition of the at least one second flow rate measurement, if the flow rate is not zero, of:
verifying at least one first condition, comprising a first primary condition, which is that the flow rate is constant;
if the at least one first condition is verified, detecting an offset problem in the measuring device.

In addition, a monitoring method such as described above is proposed, wherein the at least one first condition also comprises a first secondary condition, which is that the flow rate is less than a predetermined second threshold.

In addition, a monitoring method such as described above is proposed, wherein the detection phase comprises the steps, following the acquisition of the at least one second flow rate measurement, if the flow rate is not zero, of:
verifying at least one second condition, comprising a second primary condition, which is that the flow rate is variable;
if the at least one second condition is verified, detecting an operating defect of the valve.

In addition, a monitoring method such as described above is proposed, wherein the at least one second condition also comprises a second secondary condition, which is that the flow rate is greater than a predetermined third threshold.

In addition, a monitoring method such as described above is proposed, wherein the detection phase comprises the step of calculating a standard deviation over a predefined number of second flow rate measurements, the first primary condition being verified, when the standard deviation is less than a predetermined difference threshold, the second primary condition being verified when the standard deviation is greater than the predetermined difference threshold.

In addition, a monitoring method such as described above is proposed, wherein the detection phase comprises, following the verification step, that the valve is open, if the valve is closed, of detecting an offset problem in the measuring device.

In addition, a monitoring method such as described above is proposed, wherein the preliminary phase further comprises a step of acquiring measurements of a temperature of the fluid, the monitoring method further comprising the step of repeating the detection phase, each time that the temperature of the fluid has varied from at least one predefined temperature threshold 15 from the preceding detection phase.

In addition, a monitoring method such as described above is proposed, the detection phase being implemented at night.

In addition, a monitoring method such as described above is proposed, further comprising the step, from the moment when a leak or an offset problem or an operating defect of the valve has been detected, of separately accounting for a water consumption by the installation.

In addition, a fluid meter is proposed, comprising:
a conduit, wherein a fluid can circulate;
a measuring device arranged to measure a flow rate of the fluid;
a valve located upstream of the measuring device;
a processing unit, wherein the monitoring method such as described above is implemented.

In addition, a fluid meter such as described above is proposed, the measuring device being an ultrasonic measuring device.

In addition, a computer program comprising instructions which make the processing unit of the meter such as described above execute the steps of the monitoring method such as described above is proposed.

In addition, a computer-readable recording medium is proposed, on which the computer program such as described above is recorded.

The invention will be best understood in the light of the description below of a particular, non-limiting embodiment of the invention.

### BRIEF DESCRIPTION OF THE DRAWINGS

Reference will be made to the accompanying drawings, among which:

FIG. 1 represents a graph comprising measuring points of a zero flow rate electronic noise before calibration, and measuring points of this noise after calibration;

FIG. 2 represents an ultrasonic water meter;

FIG. 3 represents steps of the monitoring method.

### DETAILED DESCRIPTION OF THE INVENTION

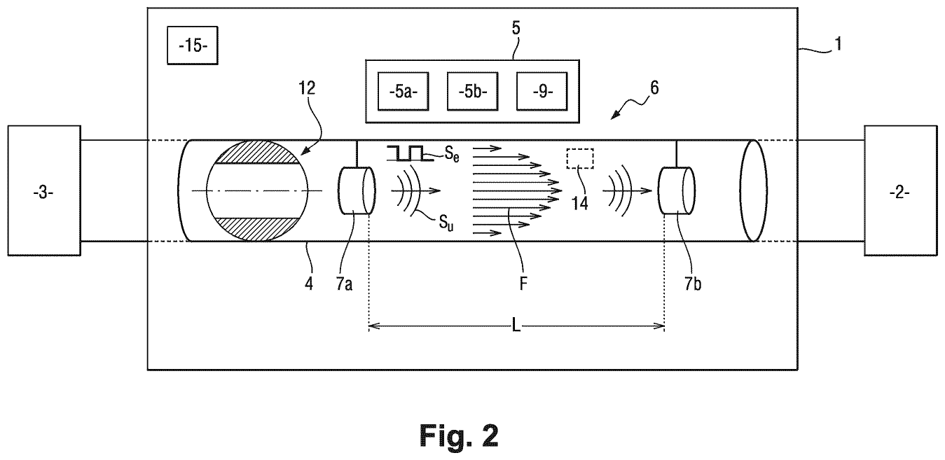

In reference to FIG. 2, the invention is implemented in an ultrasonic fluid meter 1. The meter 1 is, in this case, a water meter, which is used to measure the water consumption of the installation 2 of a subscriber. Water is supplied to the installation 2 by a water distribution network 3.

The meter 1 comprises a conduit 4, wherein the water supplied by the network 3 to the installation 2 circulates. Water circulates in the conduit 4 from upstream to downstream, as is indicated by the direction of the arrows F. In this case, by “upstream”, this means from the side of the network 3, and by “downstream”, this means the side of the installation 2.

The meter 1 comprises a processing unit 5 (electronic and software). The processing unit 5 comprises at least one processing component 5a, which is for example, a “general” processor, a processor specializing in the processing of the signal (or DSP, Digital Signal Processor), a microcontroller, or a programmable logic circuit such as an FPGA (Field Programmable Gate Array) or an ASIC (Application Specific Integrated Circuit). The processing circuit 5 also comprises one or more memories 5b, connected to or integrated in the processing component 5a. At least one of these memories 5b forms a computer-readable recording medium, on which at least one computer program is recorded, comprising instructions which make the processing component 5a execute at least some of the steps of the monitoring method which will be described below.

The meter 1 also comprises an ultrasonic measuring device 6. The ultrasonic measuring device 6 is used to measure the flow rate of water supplied to the installation 2 by the network 3.

The ultrasonic measuring device 6 comprises an upstream transducer 7a and a downstream transducer 7b. The ultrasonic measuring device 6 also comprises a processing module 9 connected to the upstream transducer 7a and to the downstream transducer 7b. The processing module 9 is, in this case, implemented in the processing unit 5.

The upstream transducer 7a and the downstream transducer 7b are advantageously (but not necessarily) paired. The upstream transducer 7a and the downstream transducer 7b are, in this case, piezoelectric transducers.

Each transducer 7a, 7b successively plays the role of an ultrasonic signal emitter and receiver.

The processing module 9 generates an excitation electric signal Se, and supplies the excitation electric signal to the emitter. The emitter thus generates an ultrasonic signal Su. The receiver receives the ultrasonic signal after this has travelled a predefined path in the fluid, and the processing module 9 measures the transit time.

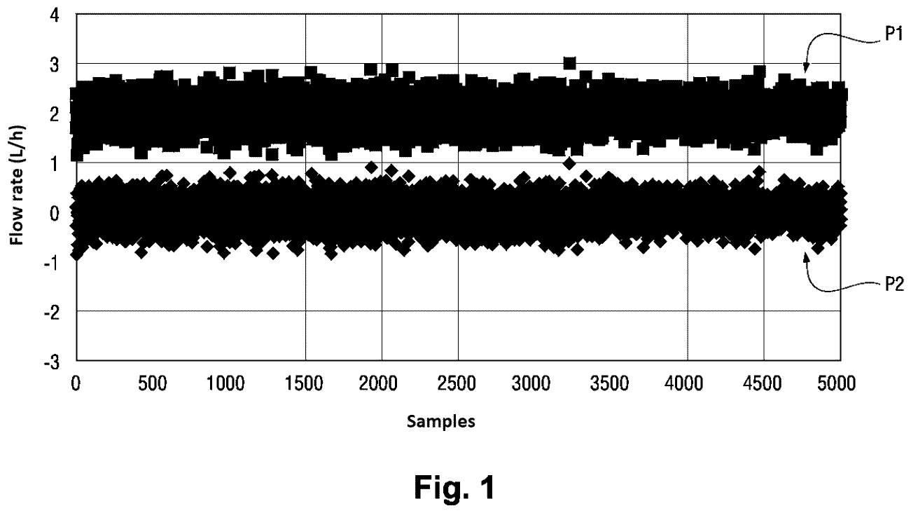

The predefined path is, in this case, a direct path (parallel with respect to a longitudinal axis of the conduit 4, as is the case in FIG. 1, or inclined with respect to said axis). The predefined path could also be an indirect path: the ultrasonic signals are thus reflected against the internal wall of the conduit (optionally against reflectors, themselves located on the internal wall).

The predefined path has a length L, which is known very specifically.

Thus, the upstream transducer 7a first emits the ultrasonic signal, which is received by the downstream transducer 7b. The processing module 9 measures the transit time between the upstream transducer and the downstream transducer.

Then, the downstream transducer 7b emits the ultrasonic signal, which is received by the upstream transducer 7a. The processing module 9 measures the transit time between the downstream transducer and the upstream transducer.

The processing module 9 calculates the speed of the water flow from the transit times, then the flow rate of the water from the speed.

The meter 1 also comprises a valve 12 which makes it possible to let water pass or to cut the water flow rate. The valve 12 is therefore a two-position valve.

The valve 12 is a motorised (electromechanical) valve: this is a solenoid valve. The valve 12 comprises a movable member which extends in the conduit 4. In this case, the valve 12 is a ball valve and the movable member is therefore a ball. The angular position of the ball can therefore be controlled, either for cutting the flow rate, or for letting water pass.

It is noted that the valve 12 could also be a multi-position valve making it possible to adjust, limit or cut the water flow rate. In this case, the valve 12 is not only dedicated to the implementation of the monitoring method described in this case, but could also fulfil another function, and for example, enable the water distributor and/or the network manager to cut or to limit the water flow rate in case of unpaid bills.

The valve 12 is positioned, along a length of the conduit 4, upstream of the two transducers 7a, 7b.

The meter 1 also comprises a temperature sensor 14, which measures a temperature of the water in the meter 1.

The meter 1 in addition comprises a communication module 15 which is able to implement any type of communication, and for example, a communication via a cellular network of the 2G, 3G, 4G, Cat-M or NB-IoT type, a communication according to the LoRa protocol, according to the W-Mbus protocol, a radio communication according to the Wize standard operating at the frequency of 169 MHz, etc.

Now, the principle of the invention is described.

If the valve 12 is open, and that the meter 1 measures a non-zero flow rate, for a relatively long duration, typically of several hours, there are three options:
either there is a real leak downstream of the meter 1, which occurs therefore either in the installation 2 of the subscriber, or at the interface between the downstream of the meter 1 and the installation 2 (in the case, for example, where the meter 1 is incorrectly connected);
or the measuring device 6 has an offset problem (incorrectly calibrated offset or deviation of the offset according to the time and/or to the temperature);
or the valve 12 has an operating defect.

The monitoring method first comprises a preliminary phase, during which the processing unit 5 acquires first flow rate measurements.

If, during the preliminary phase, the flow rate remains non-zero and less than a predetermined first threshold for at least one predetermined duration, the processing unit 5 starts a detection phase.

The predetermined first threshold is, for example, equal to 3 L/h or 5 L/h. The predetermined duration is, for example, equal to 1 h or 2 h.

During the detection phase, the processing unit 5 first verifies that the valve 12 is actually open.

If the valve 12 is closed, the processing unit 5 detects an offset problem in the measuring device 6. Indeed, the measured flow rate would have had to be zero (as the actual flow rate is actually zero, the valve 12 being closed).

If the valve 12 is actually open, the processing unit 5 closes the valve 12.

The processing unit 5 acquires at least one second flow rate measurement, in this case, several second flow rate measurements.

The processing unit 5 thus detects a water leak, if the flow rate is zero. By closing the valve 12, an actually zero flow rate has indeed been generated. If the measuring device 6 correctly measures this zero flow rate, this means that there is no offset problem nor problem on the valve 12.

However, following the acquisition of the at least one second flow rate measurement, if the flow rate is not zero, the processing unit 5:
verifies at least one first condition, comprising a first primary condition, which is that the flow rate is constant;
if the at least one first condition is verified, detects an offset problem in the measuring device 6.

In this case, the at least one first condition also comprises a first secondary condition, which is that the flow rate is less than a predetermined second threshold.

The predetermined second threshold is, in this case, equal to 5 L/h.

Indeed, if the measured flow rate is not zero, but constant, as an actually zero flow rate has been generated, this means that the measuring device 6 malfunctions and, more specifically, that there is an offset problem in the measuring device 6.

Following the acquisition of the at least one second flow rate measurement, if the flow rate is not zero, the processing unit 5:
verifies at least one second condition, comprising a second primary condition, which is that the flow rate is variable;
if the at least one second condition is verified, detecting an operating defect of the valve 12.

In this case, the at least one second condition also comprises a second secondary condition, which is that the flow rate is greater than a predetermined third threshold.

The predetermined third threshold is, in this case, equal to 10 L/h.

Indeed, if the measured flow rate is not zero, but variable, as an actually zero flow rate has been generated, this means that the valve 12 malfunctions.

Following the acquisition of the at least one second flow rate measurement, if the flow rate is not zero, the processing unit 5 therefore verifies if the flow rate is constant (first primary condition) or variable (second primary condition).

For this, the processing unit 5 calculates a standard deviation over a predefined number of second flow rate measurements, the first primary condition being verified when the standard deviation is less than a predetermined difference threshold (in this case, less than or equal), the second primary condition being verified when the standard deviation is greater than the predetermined difference threshold (in this case, strictly greater).

The predefined number is, for example, equal to 10.

The predetermined difference threshold is, for example, equal to 1 L/h.

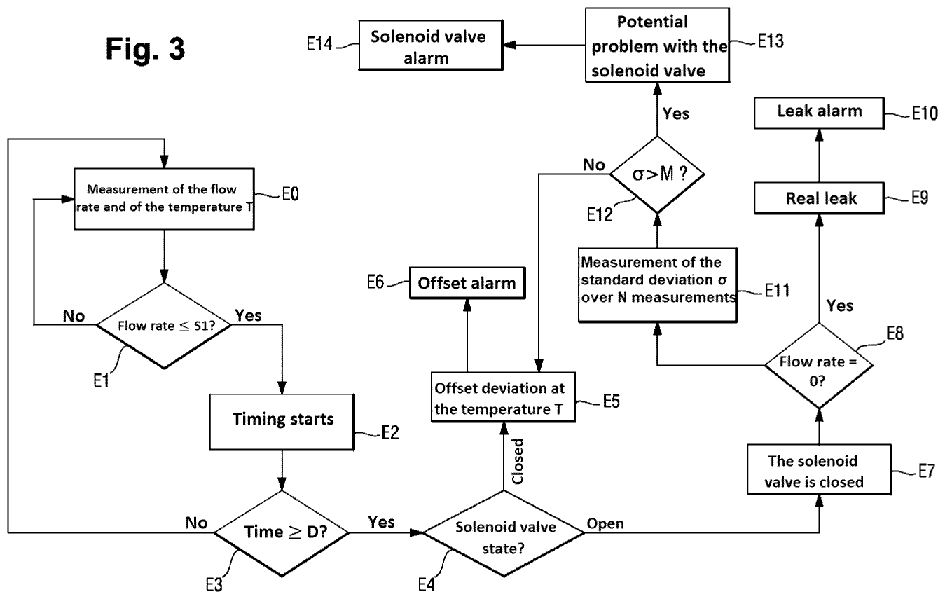

Now, a particular embodiment of the monitoring method is described, in reference to FIG. 3.

The method starts at step E0.

The processing unit 5 implements the preliminary phase and acquires the first flow rate measurements.

The processing unit 5 compares the flow rate with the predetermined first threshold S1: step E1.

S1 is, for example, equal to 3 L/h or 5 L/h.

As the flow rate is greater than S1 (in this case, strictly), the method loops over step E0 then over step E1.

When the flow rate becomes less than S1 (in this case, less than or equal), while being non-zero, the processing unit 5 starts a chronometer: step E2.

The processing unit 5 verifies if the flow rate remains non-zero and less than the predetermined first threshold S1 for at least one predetermined duration D (in this case, equal, for example, to 1h or 2h): step E3.

If this is not the case, the method returns to step E0.

If this is the case, the detection phase starts. The method moves to step E4. The processing unit 5 verifies that the valve 12 is open.

If the valve 12 is closed, the processing unit 5 detects an offset problem in the measuring device 6: step E5.

The processing unit 5 produces an alarm message indicating this offset problem: step E6.

In step E4, if the valve 12 is open, the processing unit 5 closes the valve 12: step E7.

The processing unit 5 verifies if the flow rate is zero: step E8.

If this is the case, it detects a “real” leak (step E9), and it produces an alarm message indicating the presence of this leak: step E10.

If this is not the case, the processing unit 5 verifies the first primary condition and the second primary condition (in this embodiment, the at least one first condition only comprises the first primary condition and the at least one second condition only comprises the second primary condition).

The verification of the first primary condition and of the second primary condition first consists of measuring the standard deviation σ over the predefined number (in this case, equal, for example, to 10) of second flow rate measurements: step E11.

The processing unit 5 verifies if the standard deviation σ is greater than the predetermined difference threshold M (in this case, strictly greater): step E12. The predetermined difference threshold is, for example, equal to 1 L/h.

If this is not the case, the method moves to step E5: the processing unit 5 detects an offset problem in the measuring device 6. The processing unit 5 produces an alarm message indicating this offset problem: step E6.

If this is the case, the processing unit 5 detects an operating defect of the valve 12: step E13. The processing unit 5 produces an alarm message indicating this problem linked to the valve 12: step E14.

In steps E6, E10 and E14, the alarm messages are bounced back to the water distributor and/or to the network manager via the communication module 15. The alarm messages can also be transmitted to the user. The alarms can be displayed on the screen of the meter 1.

It is recommended to repeat the detection phase for different temperatures of the water. Indeed, it can be that the meter 1 does not measure any non-zero flow rate and less than the predetermined first threshold at one or more of the given temperatures, but measures such a flow rate at one or other temperatures.

This situation is observed, for example, in case of deviation of the offset according to the temperature. For example, the offset can be well-calibrated at 20° C., but not at 40° C., such that the meter 1 will not measure any non-zero flow rate at 20° C. (in the case where, for example, the valve 12 is closed), while at a temperature close to 40° C., it will measure a false flow rate.

Thus, during the preliminary phase, and therefore in step E0 in FIG. 2, the processing unit 5 also acquires measurements of the temperature of the water produced by the temperature sensor 14.

In step E5, the offset problem is associated with the temperature of the fluid; the bounced back alarm message therefore also comprises said temperature.

The detection phase is repeated each time that the temperature of the fluid has varied from at least one predefined temperature threshold from the preceding detection phase.

The predefined temperature threshold is, for example, equal to 5° C. (this can be an increase or a drop in temperature).

Optionally, from the moment when a leak or an offset problem or an operating defect of the valve 12 has been detected, the processing unit 5 separately accounts for a water consumption by the installation 2. Thus, the overall, total consumption of the installation 2 is distinguished from the consumption of the installation 2 from the moment when the anomaly has been detected.

This makes it possible for the water distributor and/or for the network manager and/or for the user to take measures to correct and optionally compensate for the billing problems resulting from this anomaly.

It will be noted that it is advantageous to implement the detection phases during the night. The detection phases indeed require to close the valve 12 for a few instants, which cuts the water flow rate.

It is also advantageous to take the second measurements with a high frequency (for example: several measurements per second), which makes it possible to limit the closing time of the valve 12.

The advantages provided by the invention are as follows.

The invention makes it possible to carry out a continuous and precise monitoring of the flow rate and of the temperature of the fluid.

It enables a rapid identification of potential problems, such as leaks, electronic offset problems and problems linked to the valve. It therefore also makes it possible to rapidly and effectively intervene to correct the problem.

The invention minimises disruptions for the user, thanks to a limited intervention on the valve.

The meter transmits, proactively, notifications of the detected problems to the water distributor and/or to the network manager and/or to the customer, by way of alarm messages which are either displayed on the screen of the meter 1, or sent by the communication module 15.

As has been seen, it is possible to separately account for the water volume consumed in case of an identified problem, thus enabling a better management of the overall consumption of the customer.

Thus, the invention offers an effective and proactive solution for monitoring and managing problems linked to the flow rate and to the temperature of the fluids, while maintaining an optimal user experience for the user (end customer).

Naturally, the invention is not limited to the embodiment described, but comprises any variant entering into the field of the invention such as defined by the claims.

The invention naturally applies, whatever the positioning and the configuration of the upstream transducer and of the downstream transducer. Ultrasonic signals can be emitted with an orientation of any angle with respect to a longitudinal axis of the conduit.

The predefined path between the transducers is not necessarily a direct path. The ultrasonic signals, emitted and received in the conduit by the transducers can, for example, be reflected by reflectors (for example, by mirrors oriented at) 45°.

The fluid meter is not necessarily an ultrasonic meter.

The invention does not only apply to a water meter, but to any meter of any fluid: gas, oil, etc.

The valve is not necessarily a ball valve. Any type of valve can be used to cut the flow rate, for example, a slide valve.

1. A monitoring method, implemented in a fluid meter which comprises:
a conduit, wherein a fluid circulates;
a measuring device arranged to measure a flow rate of the fluid;
a valve located upstream of the measuring device; and
a processing unit;
the monitoring method being implemented in the processing unit and comprising a preliminary phase comprising the step of acquiring first flow rate measurements;
the monitoring method further comprising a detection phase, carried out when the flow rate remains non-zero and less than a predetermined first threshold, for at least one predetermined duration, and comprising the steps of:
verifying that the valve is open and, if this is the case, closing the valve;
acquiring at least one second flow rate measurement; and
detecting a fluid leak if the flow rate is zero.

2. The monitoring method according to claim 1, wherein the detection phase comprises the steps, following the acquisition of the at least one second flow rate measurement, if the flow rate is not zero, of:
verifying at least one first condition, comprising a first primary condition, which is that the flow rate is constant; and
if the at least one first condition is verified, detecting an offset problem in the measuring device.

3. The monitoring method according to claim 2, wherein the at least one first condition also comprises a first secondary condition, which is that the flow rate is less than a predetermined second threshold.

4. The monitoring method according to claim 1, wherein the detection phase comprises the steps, following the acquisition of the at least one second flow rate measurement, if the flow rate is not zero, of:
verifying at least one second condition, comprising a second primary condition, which is that the flow rate is variable; and
if the at least one second condition is verified, detecting an operating defect of the valve.

5. The monitoring method according to claim 4, wherein the at least one second condition also comprises a second secondary condition, which is that the flow rate is greater than a predetermined third threshold.

6. The monitoring method according to claim 2, wherein the detection phase comprises the steps, following the acquisition of the at least one second flow rate measurement, if the flow rate is not zero, of:
verifying at least one second condition, comprising a second primary condition, which is that the flow rate is variable; and
if the at least one second condition is verified, detecting an operating defect of the valve, wherein the detection phase comprises the step of calculating a standard deviation over a predefined number of second flow rate measurements, the first primary condition is verified when the standard deviation is less than a predetermined difference threshold (M), and the second primary condition is verified when the standard deviation is greater than the predetermined difference threshold.

7. The monitoring method according to claim 1, wherein the detection phase comprises, following the verification step, that the valve is open, if the valve is closed, of detecting an offset problem in the measuring device.

8. The monitoring method according claim 1, wherein the preliminary phase further comprises the step of acquiring measurements of a temperature of the fluid, and the monitoring method further comprises the step of repeating the detection phase each time that the temperature of the fluid has varied from at least one predefined temperature threshold from the preceding detection phase.

9. The monitoring method according to claim 1, wherein the detection phase is implemented at night.

10. The monitoring method according to claim 1, further comprising the step, from the moment when a leak or an offset problem or an operating defect of the valve has been detected, of separately accounting for a water consumption by the installation.

11. A fluid meter, comprising:
a conduit wherein a fluid can circulate;
a measuring device arranged to measure a flow rate of the fluid;
a valve located upstream of the measuring device; and
a processing unit, wherein the monitoring method according to claim 1 is implemented.

12. The fluid meter according to claim 11, wherein the measuring device is an ultrasonic measuring device.

13. (canceled)

14. A non-transitory computer-readable recording medium, on which a computer program comprising instructions which make a processing unit of a meter execute the steps of the monitoring method according to claim 1 is recorded.
